(19) United States
(12) Patent Application Publication
(10) Pub. No.: US 2010/0043739 A1
(43) Pub. Date: Feb. 25, 2010

(54) Balance weight system of crankshaft

(75) Inventor: Pil Sung Jang, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/357,769

(22) Filed: Jan. 22, 2009

(30) Foreign Application Priority Data
Aug. 25, 2008 (KR) 10-2008-0082895

(51) Int. Cl. F02B 75/06; F16C 3/20

(52) U.S. Cl. 123/192.2; 74/603

(57) ABSTRACT

A balance weight system of a crankshaft includes a first balance weight in which a mass center thereof ranges from approximately +78 to approximately +82 degrees based on the horizontal line, a ninth balance weight in which a mass center thereof ranges from approximately −82 to approximately −78 degrees, a second balance weight in which a mass center thereof ranges from approximately +86.5 to approximately +89 degrees, a eighth balance weight in which a mass center thereof ranges from approximately −89 to approximately −86.5 degrees, and at least one balance weight group of which size of rotational inertia moment thereof ranges from approximately 13 to approximately 17% compared with the first or ninth balance weight, wherein rotational inertia moment size of the second and eighth balance weights ranges from approximately 15 to approximately 25% compared with the first and ninth balance weights.

### CROSS-REFERENCE TO RELATED APPLICATIONS

The present application claims priority to Korean Patent Application No. 10-2008-0082895 filed on Aug. 25, 2008, the entire contents of which application is incorporated herein for all purposes by this reference.

### BACKGROUND OF THE INVENTION

1. Field of the Invention

The present invention relates to a crankshaft, and more particularly to a balance weight system of a crankshaft of which durability of a bearing is improved and the weight thereof is reduced.

2. Description of Related Art

Generally, balance and weight are important factors in designing a crankshaft.

However, a bearing supporting the crankshaft is not substantially considered such that durability and lubrication characteristics thereof are deteriorated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a balance weight system of a crankshaft having a light weight as well as improved durability of a supporting bearing by increasing the thickness of a lubricant film.

In an aspect of the present invention, a balance weight system of a crankshaft, including balance weights that are sequentially disposed in a length direction of a crankshaft from a first crank pin, wherein in case that the first crank pin is in a position of +90 degrees based on a horizontal line (X axis), the balance weights may have a first balance weight in which a mass center thereof ranges from approximately +78 to approximately +82 degrees based on the horizontal line, a ninth balance weight in which a mass center thereof ranges from approximately −82 to approximately 78 degrees based on the horizontal line, a second balance weight in which a mass center thereof ranges from approximately +86.5 to approximately +89 degrees based on the horizontal line, a eighth balance weight in which a mass center thereof ranges from approximately −89 to approximately −86.5 degrees based on the horizontal line, and at least one balance weight group of which size of rotational inertia moment thereof ranges from approximately 13 to approximately 17% compared with the first or ninth balance weight, wherein rotational inertia moment size of the second and eighth balance weights ranges from approximately 15 to approximately 25% compared with the first and ninth balance weights.

The balance weight group may include a third balance weight, a fourth balance weight, a sixth balance weight, and a seventh balance weight in sequence, wherein the balance weight group is disposed between the second and eight balance weights.

Specification of the fifth balance weight may be determined corresponding to mass center and rotational inertia moment of the first to fourth balance weights and the sixth to ninth balance weights, wherein the fifth balance weight is configured for entire mass center of the crankshaft to be on center axis of the crankshaft according to the mass center and the rotational inertia moment of the first to fourth balance weights and the sixth to ninth balance weights.

The first and second balance weights may be disposed corresponding to the first crank pin, and the eighth and ninth balance weights are disposed corresponding to a sixth crank pin that is mounted at an opposite side of the first crank pin.

In an aspect of the present invention, a balance weight system of a crankshaft, comprising balance weights that are sequentially disposed in a length direction of a crankshaft from a first crank pin, wherein in case that the first crank pin is in a position of +90 degrees based on a horizontal line (X axis), the balance weights may include a first balance weight in which a mass center thereof ranges from approximately +78 to approximately +82 degrees based on the horizontal line.

The balance weight system may further include a second balance weight in which a mass center thereof ranges from approximately +86.5 to approximately +89 degrees based on the horizontal line.

The balance weight system may further include a eighth balance weight in which a mass center thereof ranges from approximately −89 to approximately −86.5 degrees based on the horizontal line.

The balance weight system may further include a ninth balance weight in which a mass center thereof ranges from approximately −82 to approximately −78 degrees based on the horizontal line.

The balance weight system may further include at least one balance weight group of which size of rotational inertia moment thereof ranges from approximately 13 to approximately 17% compared with the first or ninth balance weight, Rotational inertia moment size of the second and eighth balance weights may range from approximately 15 to approximately 25% compared with the first and ninth balance weights.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary balance weight system according to the present invention.

FIG. 2 is a perspective view of components of an exemplary balance weight system according to the present invention.

FIG. 3 is a side view of components of an exemplary balance weight system according to the present invention.

FIG. 4 is a table showing characteristics of components of an exemplary balance weight system according to the present invention.

FIG. 5 is a graph showing experimental cases of an exemplary balance weight system according to the present invention.

FIG. 6 is a table showing experimental data of an exemplary balance weight system according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

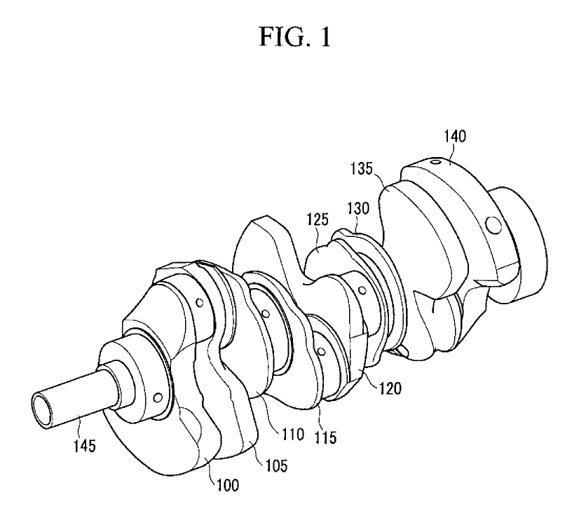

FIG. 1 is a perspective view of a balance weight system according to various embodiments of the present invention.

Referring to FIG. 1, a balance weight system includes a crankshaft 145, a first balance weight 100, a second balance weight 105, a third balance weight 110, a fourth balance weight 115, a fifth balance weight 120, a sixth balance weight 125, a seventh balance weight 130, an eighth balance weight 135, and a ninth balance weight 140.

As shown, the balance weights (100, 105, 110, 115, 120, 125, 130, 135, and 140) are sequentially disposed in a length direction of the crankshaft 145 from the first crank pin to absorb vibration when the crankshaft 145 rotates.

Further, one side of the crankshaft 145 between the balance weights (100, 105, 110, 115, 120, 125, 130, 135, and 140) is respectively securely supported by a bearing.

In this case, lubricant is interposed between the bearing and the supporting surface of the crankshaft 145 to reduce friction/abrasion, and it is desirable that the thickness of the interposed lubricant film is thicker than a predetermined value.

In various embodiments of the present invention, the mass center and the rotational inertia moment of the balance weights (100, 105, 110, 115, 120, 125, 130, 135, and 140) are respectively designed to reduce the weight of the balance weights (100, 105, 110, 115, 120, 125, 130, 135, and 140) and to improve the durability and friction/abrasion characteristics of the crankshaft 145 and the bearing.

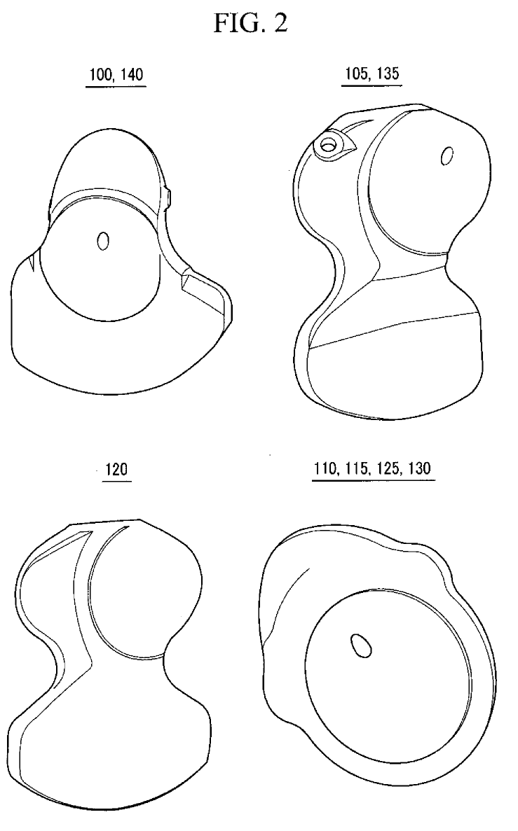

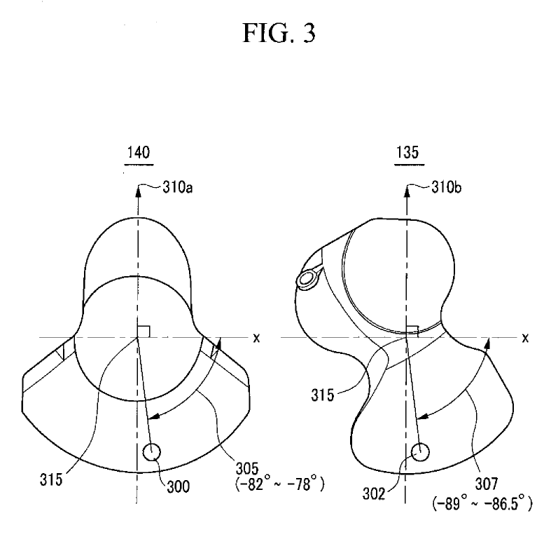

The characteristic of the balance weights (100, 105, 110, 115, 120, 125, 130, 135, and 140) will be described referring to FIG. 2 and FIG. 3.

FIG. 2 is a perspective view of components of a balance weight system according to various embodiments of the present invention.

Referring to FIG. 2, the first and ninth balance weights 100 and 140 have equal or similar shapes to each other, but the rotation positions thereof are at opposite sides.

Also, the second and eighth balance weights 105 and 135 also have equal or similar shapes to each other, but the rotation positions thereof are at opposite sides.

Further, the third, fourth, sixth, and seventh balance weights (110, 115, 125, and 130) have equal or similar shapes to each other, and the shape of the fifth balance weight 120 is determined corresponding to the mass center and the rotational inertia moment of the first to fourth and the sixth to ninth balance weights.

The specification of the fifth balance weight 120 is determined based on the mass center and the rotational inertia moment of the first to fourth and sixth to ninth balance weights for the entire mass center of the crankshaft to be disposed at the center axis of the crankshaft.

FIG. 3 is a side view of components of a balance weight system according to various embodiments of the present invention.

Referring to FIG. 3, the mass center 300 of the ninth balance weight 140 has an angle 305 ranging from −82 to −78 degrees in a clockwise direction from a horizontal line (X axis). While not shown, the mass center of the first balance weight 140 has a predetermined angle ranging from +78 to +82 degrees, compared with the ninth balance weight that is disposed at an opposite side thereof.

In this instance, a base line 310a passing through the center of the first crank pin is 90 degrees from the horizontal line based on a rotation center 315 of the crankshaft 145, and the mass center 300 of the ninth balance weight 140 has an angle ranging from 168 to 172 degrees from the base line 310a in a clockwise direction.

Further, the mass center 302 of the eighth balance weight 135 has a predetermined angle 307 ranging from −89 to −86.5 degrees from the horizontal line. While not shown, the mass center of the second balance weight 105 that is disposed at an opposite side to the eighth balance weight has a predetermined angle of +86.5 to +89 degrees from the horizontal line.

In this instance, the base line 310b passing through the center of the first crank pin is 90 degrees from the horizontal line based on the rotation center 315 of the crankshaft 145, and the mass center of the eighth balance weight 135 has an angle ranging from 176.5 to 179 degrees from the base line 310 in a clockwise direction from the horizontal line.

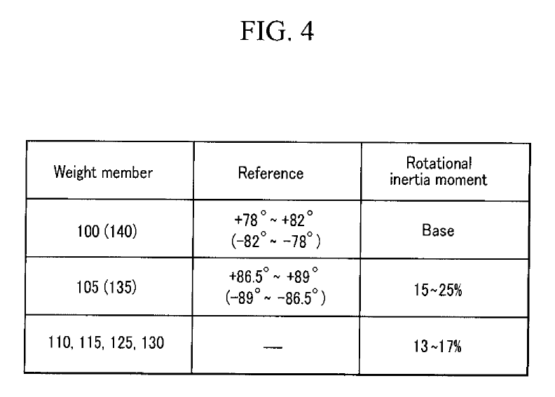

FIG. 4 is a table showing characteristics of components of a balance weight system according to various embodiments of the present invention.

Referring to FIG. 4, the mass centers of the first and ninth balance weights 100 and 140 range from +78 to +82 degrees or from −78 to −82 degrees from the horizontal line, and the mass centers of the second and eighth balance weights 105 and 135 range from +86.5 to +89 degrees or from −86.5 to −89 degrees from the horizontal line.

Further, the rotational inertia moments of the second and eighth balance weights 105 and 135 are in a range of 15 to 25% compared with those of the first and ninth balance weights 100 and 140. Also, the rotational inertia moments of the third, fourth, sixth and seventh balance weights (110, 115, 125, and 130) are in a range of 13 to 17% compared with those of the first and ninth balance weights 100 and 140.

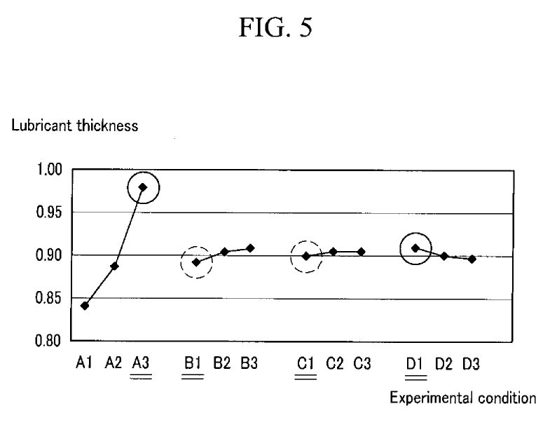

FIG. 5 is a graph showing experimental cases of a balance weight system according to various embodiments of the present invention.

Referring to FIG. 5, the horizontal axis shows experimental conditions according to predetermined control values, and the vertical axis shows a lubricant film thickness on the bearing supporting the crankshaft 145.

As described above, a plurality of experimental conditions can be adjusted according to the mass center and the rotational inertia moment of the first and ninth balance weights 100 and 140, the second and eighth balance weights 105 and 135, and the third, fourth, sixth, and seventh balance weights (110, 115, 125, and 130) in a predetermined range.

As shown, it is determined that A3, B3, C3, and D1 are satisfactory in the aspect of lubricant film thickness, and the A3, B1, C1, and D1 are satisfactory considering other conditions such as vibration and so on.

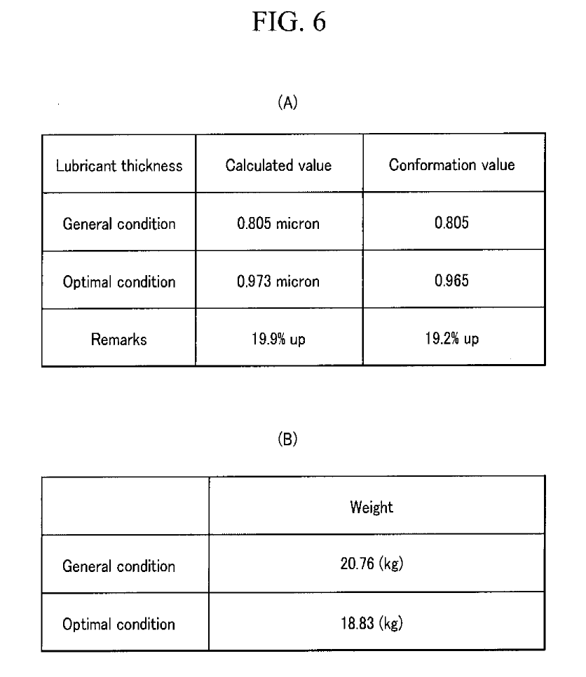

FIG. 6 is a table showing experimental data of a balance weight system according to various embodiments of the present invention.

Referring to (A) of FIG. 6, the general lubricant thickness that is formed at the bearing supporting the crankshaft 145 is calculated to be 0.805 microns, and the actual detected value is 0.805 microns.

According to various embodiments of the present invention, the calculated lubricant thickness is 0.973 microns in the optimal condition and the actual detected value is 0.965 microns. That is, it can be confirmed that the lubricant film thickness increases about 20%.

Referring to (B) of FIG. 6, the general crankshaft set having the balance weight weighs 20.76 kg, but the crankshaft set having the balance weight in the optimal experimental condition weighs 18.83 kg according to various embodiments of the present invention wherein the weight reduction is achieved.

If the crankshaft is designed by only considering the weight, the durability of the bearing can be deteriorated, but the weight of the crankshaft as well as the durability of the bearing can be optimized together in various embodiments of the present invention.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A balance weight system of a crankshaft, comprising balance weights that are sequentially disposed in a length direction of a crankshaft from a first crank pin, wherein in case that the first crank pin is in a position of +90 degrees based on a horizontal line (X axis), the balance weights include:
a first balance weight in which a mass center thereof ranges from approximately +78 to approximately +82 degrees based on the horizontal line;
a ninth balance weight in which a mass center thereof ranges from approximately −82 to approximately −78 degrees based on the horizontal line;
a second balance weight in which a mass center thereof ranges from approximately +86.5 to approximately +89 degrees based on the horizontal line;
a eighth balance weight in which a mass center thereof ranges from approximately −89 to approximately −86.5 degrees based on the horizontal line; and
at least one balance weight group of which size of rotational inertia moment thereof ranges from approximately 13 to approximately 17% compared with the first or ninth balance weight,
wherein rotational inertia moment size of the second and eighth balance weights ranges from approximately 15 to approximately 25% compared with the first and ninth balance weights.

2. The balance weight system of a crankshaft of claim 1, wherein the balance weight group includes a third balance weight, a fourth balance weight, a sixth balance weight, and a seventh balance weight in sequence.

3. The balance weight system of a crankshaft of claim 2, wherein the balance weight group is disposed between the second and eight balance weights.

4. The balance weight system of a crankshaft of claim 2, wherein specification of the fifth balance weight is determined corresponding to mass center and rotational inertia moment of the first to fourth balance weights and the sixth to ninth balance weights.

5. The balance weight system of a crankshaft of claim 4, wherein the fifth balance weight is configured for entire mass center of the crankshaft to be on center axis of the crankshaft according to the mass center and the rotational inertia moment of the first to fourth balance weights and the sixth to ninth balance weights.

6. The balance weight system of a crankshaft of claim 1, wherein the first and second balance weights are disposed corresponding to the first crank pin, and the eighth and ninth balance weights are disposed corresponding to a sixth crank pin that is mounted at an opposite side of the first crank pin.

7. A passenger vehicle comprising a balance weight system of a crankshaft of claim 1.

8. A balance weight system of a crankshaft, comprising balance weights that are sequentially disposed in a length direction of a crankshaft from a first crank pin, wherein in case that the first crank pin is in a position of +90 degrees based on a horizontal line (X axis), the balance weights include:
a first balance weight in which a mass center thereof ranges from approximately +78 to approximately +82 degrees based on the horizontal line.

9. The balance weight system of a crankshaft of claim 8, further comprising, a second balance weight in which a mass center thereof ranges from approximately +86.5 to approximately +89 degrees based on the horizontal line.

10. The balance weight system of a crankshaft of claim 9, further comprising, a eighth balance weight in which a mass center thereof ranges from approximately −89 to approximately −86.5 degrees based on the horizontal line.

11. The balance weight system of a crankshaft of claim 10, further comprising, a ninth balance weight in which a mass center thereof ranges from approximately −82 to approximately −78 degrees based on the horizontal line.

12. The balance weight system of a crankshaft of claim 11, further comprising, at least one balance weight group of which size of rotational inertia moment thereof ranges from approximately 13 to approximately 17% compared with the first or ninth balance weight,

13. The balance weight system of a crankshaft of claim 11, wherein rotational inertia moment size of the second and eighth balance weights ranges from approximately 15 to approximately 25% compared with the first and ninth balance weights.

14. A passenger vehicle comprising a balance weight system of a crankshaft of claim 8.
